(19) United States
(12) Patent Application Publication
(10) Pub. No.: US 2008/0022202 A1
(43) Pub. Date: Jan. 24, 2008

(54) Image inversion

(76) Inventors: Murray D. Craig, Fort Collins, CO (US); Robert P. Cazier, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/489,337

(22) Filed: Jul. 19, 2006

(51) Int. Cl. G11B 27/00; H04N 7/173

(52) U.S. Cl. 715/716; 715/726; 715/723; 715/719

(57) ABSTRACT

A method comprises selecting a first center point for a first portion of an image, copying the first portion, centered about the first center point, to a buffer; and inverting the copied first portion about a first edge of said portion.

### BACKGROUND

Digital photography has stimulated the desire of photography enthusiasts to be able produce images with different types of special effects applied to the images.

### BRIEF DESCRIPTION OF THE DRAWINGS

For a detailed description of exemplary embodiments of the invention, reference will now be made to the accompanying drawings in which:

FIGS. 1A and 1B show examples of reflected images produced in accordance with embodiments of the invention;

FIG. 2 shows an illustrative block diagram of digital image capture system in accordance with embodiments of the invention;

FIG. 3 shows an illustrative view of the user interface of the digital image capture device of FIG. 2;

FIG. 4 shows a flow chart of a method in accordance with embodiments of the invention;

FIGS. 5-7 illustrate the selection of a center point of a portion of an image for purposes of generating a reflected image;

FIGS. 8-10 illustrate various interim steps in generating the reflected image; and

FIG. 11 illustrates the application of the reflected effect of a down-sampled image to a full version of the down-sampled image.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

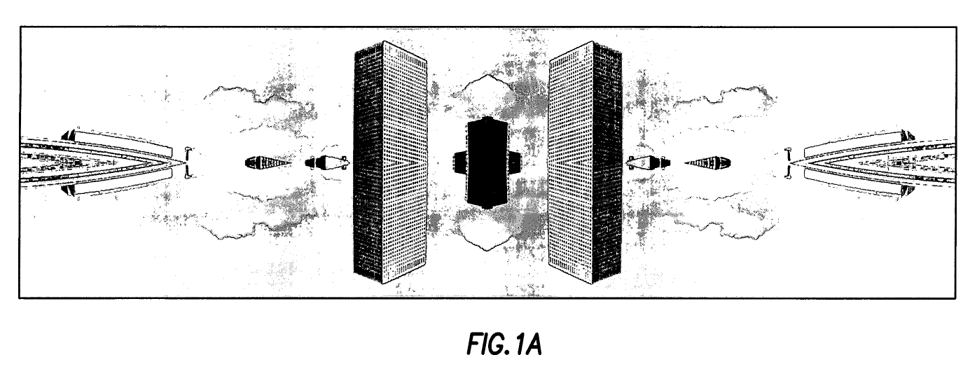

The embodiments disclosed herein relate to a special effect in which a reflected version of an input image is generated. FIGS. 1A and 1B show examples of such reflected images. In FIG. 1A, an input image of office buildings has been processed so as to create a kaleidoscope-like effect as shown. The reflected image of FIG. 1B is based on an input image of trees. The user has control over how the reflective effect is applied to a given input image to thereby permit the user to apply considerable creativity.

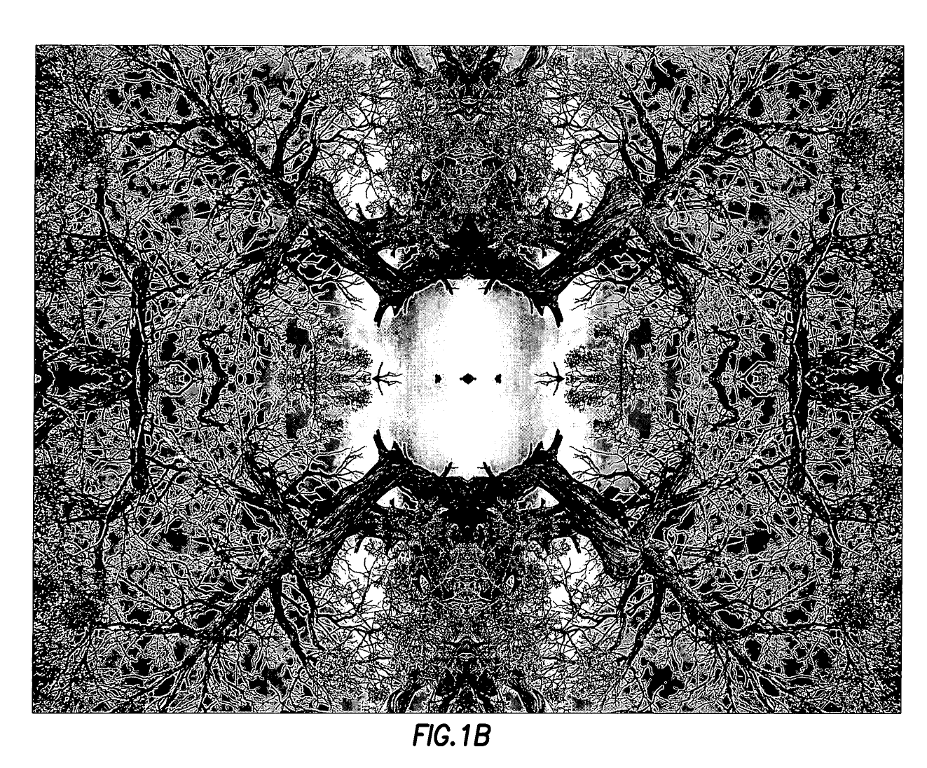

In at least one embodiment of the invention, the mechanism that takes an input image and permits a user to generate a reflected version of that input image is provided in an image acquisition device such as a digital camera. FIG. 2 shows an illustrative block diagram of just such a digital camera. Digital camera 100 in FIG. 2 comprises a processor 102, fixed non-volatile storage 104, removable non-volatile storage 106, volatile storage 114, an image capture module 120, input controls 126, and a display 130. The various components are coupled together as shown in FIG. 2, although other arrangements and configurations are possible as well.

The fixed non-volatile storage 104 comprises software 108 that is executed by processor 102. Storage 104 is fixed in that, in at least some embodiments, storage 104 is not readily removable from the camera 100 by a user. Non-volatile storage 106, however, is removable. In some embodiments, non-volatile storage 106 comprises a removable storage device such as Secure Digital (SD) card, Compact Flash card, etc. on which images captured by the image capture module 120 are stored. The software 108 causes the processor 102 to perform various actions. Such actions include, for example, activating the image capture module 120 to acquire an image per user input via one or more of the input controls 126, causing the previously captured images that are stored on the removable non-volatile storage 106 to be viewed on display 130, and performing the methods described herein to generate a reflected image.

The method for generating a reflected image described herein can be implemented in software. In other embodiments, hardware or a combination of hardware and software are possible as well to implement the method. For software-based implementations, the software can be stored on any of a variety of storage media such as volatile memory (e.g., random access memory), non-volatile storage such as fixed non-volatile storage 114 (or a hard disk drive, compact disc read only memory (CD ROM), etc.), and combinations thereof.

Volatile storage 114 comprises random access memory (RAM) in accordance with at least some embodiments of the invention. Volatile storage 114 is used as a temporary scratchpad memory for the processor to use while executing software 108. Further, in some embodiments an image to be processed for reflection first is copied from non-volatile storage 106 to volatile storage 114 and the copy of the image on the non-volatile storage 106 is then processed. Following generation of the reflected image, which is stored on the volatile storage 114, the reflected image is copied to non-volatile storage 106.

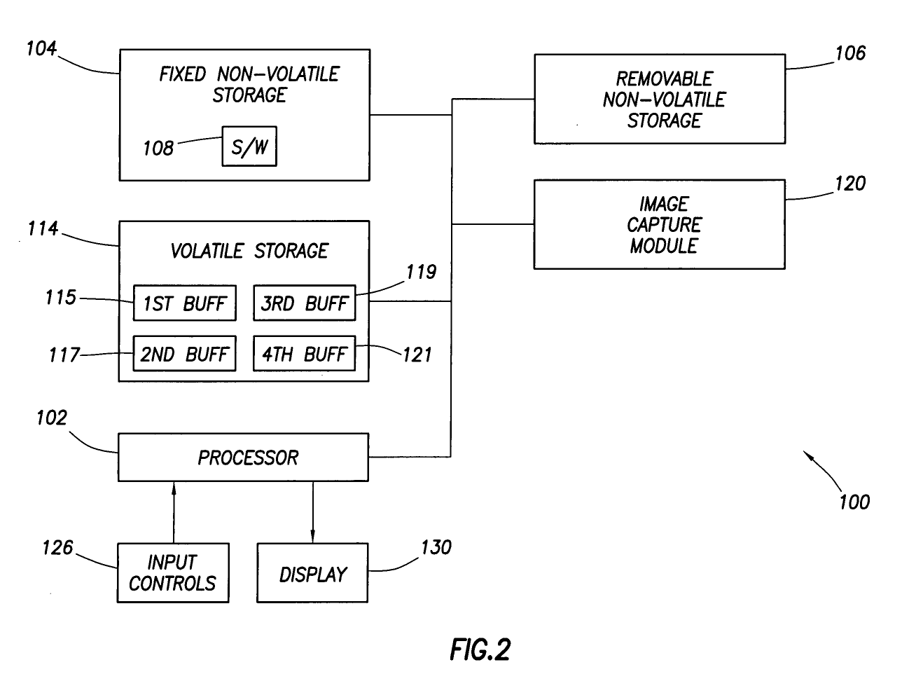

FIG. 3 shows a rear view of the digital camera 100. Images captured using the camera are shown on display 130. Menu choices and other textual information also can be shown on the display and, in at least some cases, menu choices are superimposed over the displayed image. The input controls 126 shown in FIG. 2 include various controls shown in FIG. 3 such as a cursor control 126a and a “Menu/OK” button 126f. An embodiment of the cursor control 126a comprises a four-part rocker button comprising rocker segments 126b, 126c, 126d, and 126e. Segments 126b and 126c comprise up and down cursor segments, while 126d and 126e comprise left and right cursor segments. Pressing the Menu/OK button 126f causes a menu of selectable options to be shown on the display 130. Using the four-part rocker button 126a and the Menu/OK button 126f enables a user to scroll through the list of menu options and select the option the user desires.

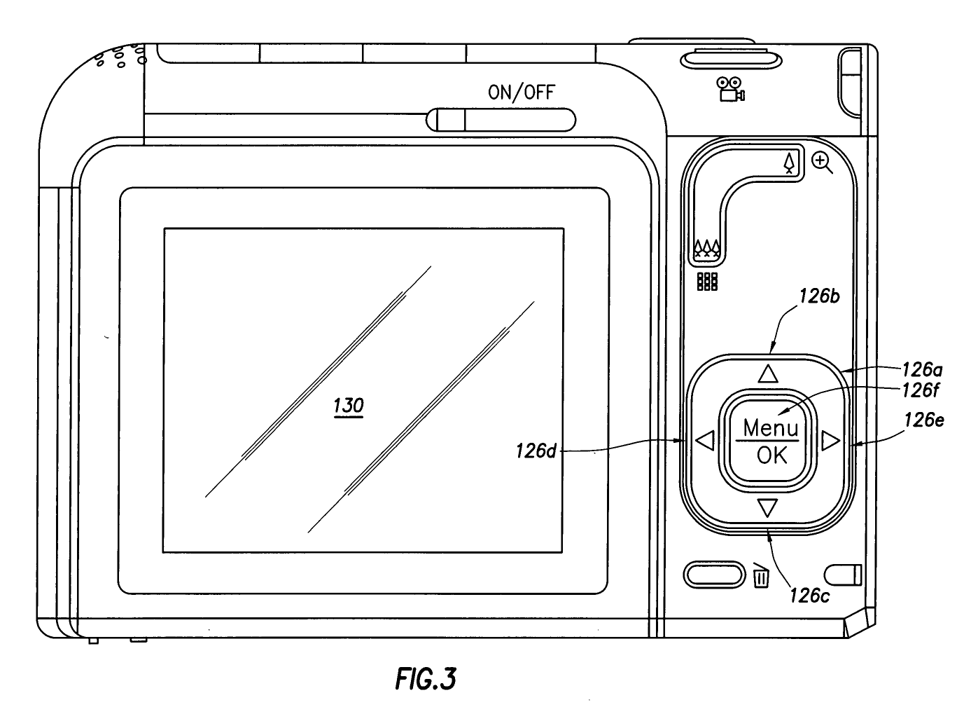

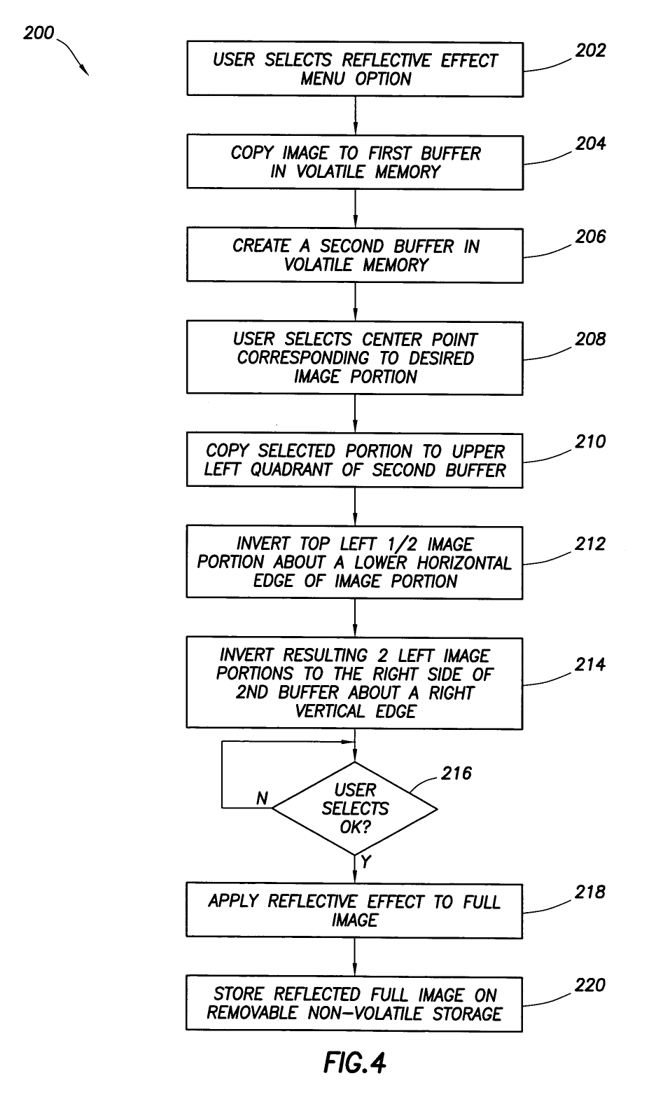

FIG. 4 shows a method 200 of generating an inverted image from an input image. In some embodiments, the method 200 is implemented in software such as software 108 on camera 100 (FIG. 2). In other embodiments, method 200 is implemented in software on a personal computer. The following discussion of method 200 of FIG. 4 will include references to FIGS. 5-10.

Method 200 processes an input image to generate an inverted version of at least a portion of that image. The input image may be an image acquired using the image capture module 120 of camera 100 or the input image may have been acquired or generated via another mechanism in the past. The image may have been acquired or generated by a variety of sources. FIG. 5 shows an example of image that will be discussed in accordance with method 200. For simplicity in illustrating the method, the image simply comprises lines 250 and 252. The image, however, could be of anything. The images of FIGS. 1A and 1B are two other examples of images to which method 200 has been applied.

While viewing, on display 130, the image to which the user desires to apply the reflective effect, at 202 (FIG. 4) the user presses the Menu/OK button 126f to show various menu choices on the display. Through one or more menus of choices, the user finds the reflection effect menu option and selects such option by again pressing the Menu/OK button 126f.

The reflection effect permits a user to select a portion of the input image. In the embodiments disclosed herein, the selected portion comprises a rectangular portion of the input image. In at least some embodiments, the rectangular portion has a width that is one-half of the width of the input image and has a height that is one-half of the input image's height (i.e., one-quarter of the input image). The width and height of the images and image portions are measured in terms of number of pixels defining the images and portions. The selected one-half width, one-half height portion is then inverted as described below to create the reflected image.

The input image in at least some embodiments is stored on removable non-volatile storage 106. Accessing data in volatile memory 114, however, is generally faster than accessing data from the removable non-volatile storage 106. Accordingly, at 204 the image is copied from removable non-volatile storage 106 to a first buffer 115 in volatile memory 114 for further processing therefrom. At 206, a second buffer 117 is created in the volatile memory 114 into which the reflected image is stored. The first and second buffers are of the same or comparable size.

At 208, the user presses the left/right/up down cursor segments 126b-126e to select the one-half width, one-half height portion of the input image for inverting. In accordance with at least some embodiments, 25 different image portions are selectable by the user-five along a horizontal axis and five along a vertical axis. FIG. 5 shows 25 points labeled as 248 with each point 248 representing the center of a portion of the total image. FIG. 5 illustrates one such portion 240 (in dashed outline) which is centered about point 249. FIGS. 6 and 7 illustrate two other exemplary portions 242 and 244, respectively. Portion 242 is centered about point 251, while portion 244 is centered about point 253. Each such portion centered on one of the points 248 has a width equal to one-half of the width of the input image and a height equal to one-half of the input image's height. In other embodiments, the width and/or height of each selected portion can be equal to other than one-half of the input image's width and height.

By pressing the left/right/up down cursor segments 126b-126e, any one of the 25 possible image portions can be selected. In some embodiments, the user, however, is not presented with a direct visual indication as to which center point the user has selected. In some such embodiments, the initial default image portion is portion 242 which is centered about outermost point 251. From there, the user can change the selected center point up, down, left and right. Each time the user selects a new center point and corresponding image portion, method 200 processes the selected portion to apply the reflected effect as explained below. The camera 100 is generally able to apply the reflected effect fast enough (in less than about one second in some embodiments) so that the user can promptly see the result of the effect.

In other embodiments, the user is shown a graphical image of a box on the display 130, the box corresponding to one of the 25 possible portions. The user can move the box around on the screen by selecting different center points via cursor control 126a. The user will then select the Menu/OK button 126f once the desired box location is selected to have the reflected effect applied.

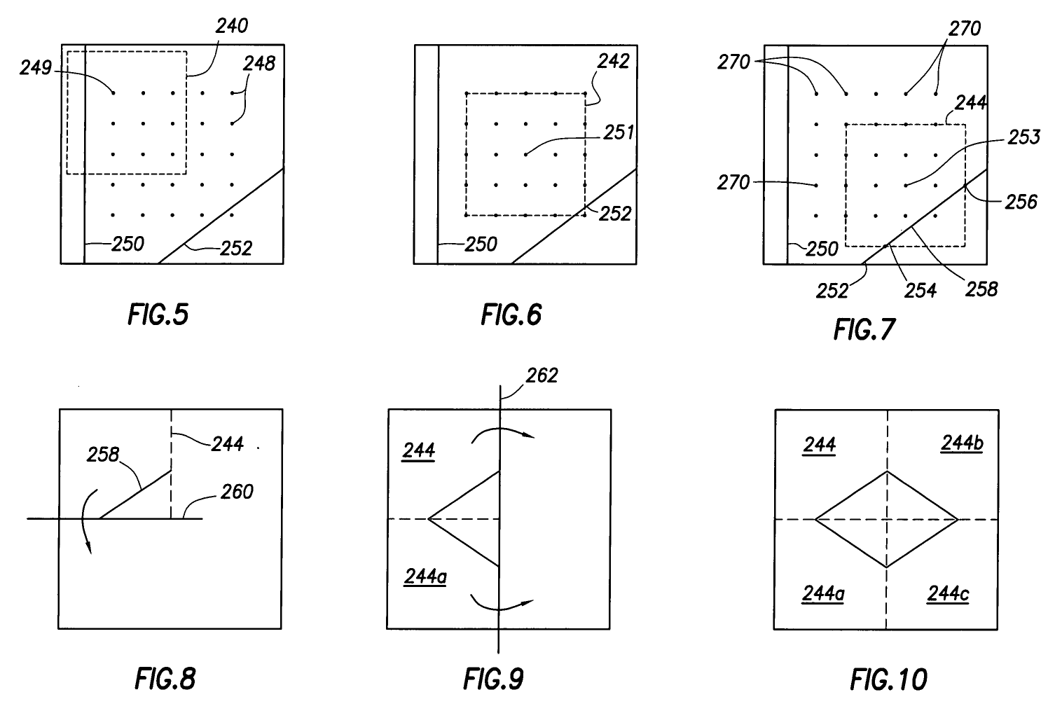

The example described below assumes the user has selected image portion 244 centered about point 253 (FIG. 7). As can be seen, image portion 244 comprises part of line 252 that passes through portion 244 between points 254 and 256. At 210, the selected image portion 244 is copied from the first buffer 115 to the upper left quadrant of the second buffer 117. FIG. 8 illustrates the contents of the second buffer as comprising, in its upper left-hand quadrant, image portion 244. The rest of the second buffer 117 is blank, that is, does not contain valid image data.

At 212, the image portion 244 in the upper left-hand quadrant of the second buffer is inverted about an edge 260 of portion 244. The edge 260 represents, in at least some embodiments, the bottom edge of image portion 244. Inverting the image portion 244 about edge 260 results in image portion 244 being copied into the lower left-hand quadrant of the second buffer while at the same time inverting the image about horizontal edge 260. The result of the inversion is illustrated in FIG. 9 as initial image portion 244 and inverted image portion 244a. The process of inverting the image portions involves copying pixels from one location in the second buffer 117 to a corresponding location in the second buffer so as to invert the image portion.

At 214, the two left-hand image portions, representing the initial portion 244 and the inverted image portion 244a, are inverted about an edge 262. The edge 262 represents, in at least some embodiments, the right-hand vertical edge of image portions 244 and 244a. Edge 262 is orthogonal to edge 260 in this example, although in other examples, the two edges need not be orthogonal to one another. Inverting the image portions 244, 244a about edge 262 results in image portions 244b and 244c as shown in FIG. 10.

The reflective effect has been applied to the image copied to the first buffer 115 at 204. In some embodiments, the image may have been the “full” image acquired by the image capture module 120. In a camera having a resolution of, six megapixels, for example, the full image would comprise 6,000,000 pixels of image data. Processing that much data, however, may take more time than a user of the camera 100 is willing to wait. The display 130 of the camera has a lower resolution than the resolution of the image capture module 120. For example, the display 130 may have a resolution of 320×240 pixels (76,800 pixels of image data). The full image is down-sampled to show the image on display 130. In the embodiment of FIG. 4, actions 204-214 are performed on the down-sampled image so that the reflective effect can more quickly be implemented and shown to the user.

Each time the user presses the left, right, up, or down arrow cursor segments 126b-126e (of FIG. 3), the software 108 performs actions 210-214 (of FIG. 4) to render a reflected image on the camera's display 130. Thus, each press of a cursor segment 126b-126e causes the displayed reflected image to be changed in accordance with a newly selected initial image portion. If the user has selected one of the center points at the periphery of the array of center points (e.g., peripheral points 270 in FIG. 7), any further activation of a cursor segment that would otherwise attempt to move beyond the peripheral center points does nothing. That is, the selected center point does not change and the reflected image that is already shown on display 130 does not change.

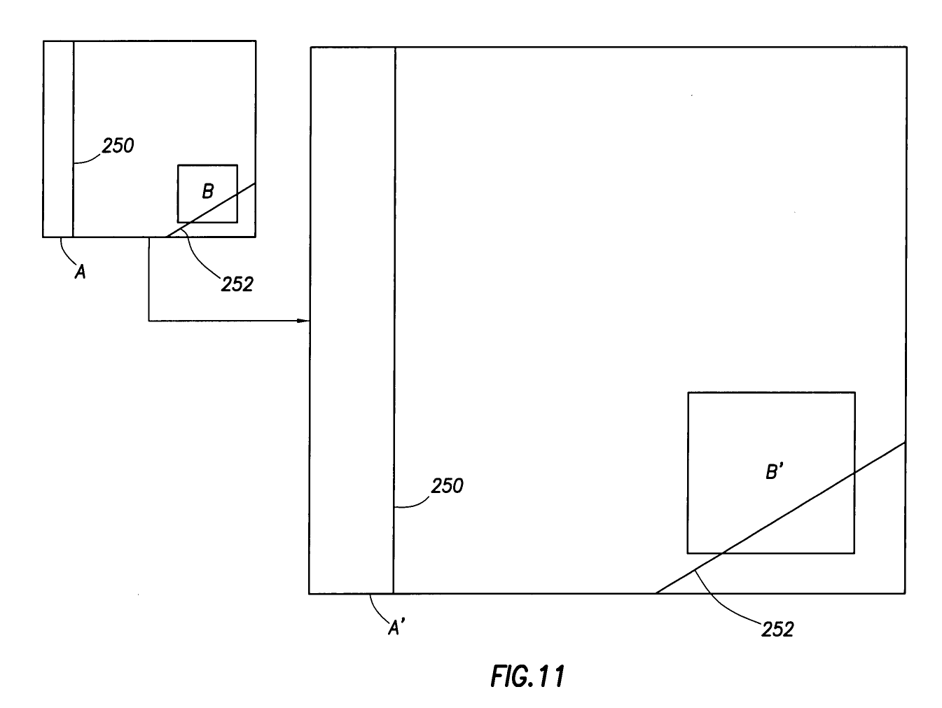

At any time while viewing a reflected image, the user can press the Menu/OK button 126f, as determined at 216 in FIG. 4. Upon pressing the Menu/OK button 126f, the reflective effect, that up to that point has been applied on the down-sampled image, is applied to the full image at 218 with the resulting reflected image being stored back on the removable non-volatile storage 106. The full image is copied from the removable non-volatile storage 106 to a third buffer 119, in volatile memory 114 of sufficient size to hold the full image. A fourth buffer 121 is also created and used in which to copy the portion of the full image for subsequent inversion. The portion of the full image that is selected to which to apply the reflective effect corresponds to the portion that had been selected of the down-sampled image when the user pressed the Menu/OK button 126f. By way of example, FIG. 11 shows a down-sampled image A and its full version A′. Image portion B has been selected by the user as described above (e.g., with regard to FIG. 2, steps 202-214) for the reflective effect. At 218 in FIG. 4, the reflective effect is applied to the corresponding portion B′ of the full image A′.

In accordance with another embodiment of the invention, the image portion being reflected is offset before the two inversion actions 212 and 214 (and corresponding inversion actions for the full image) are applied. The option for implementing this feature is selectable by a user via input controls 126. The user can specify the amount of offset via the input controls 126. The effect may be to move the image left or right or up or down as desired.

In some embodiments, the initial image portion is inverted about two axes. In other embodiments, the image portion can be inverted about only a single axis (e.g., a horizontal axis, a vertical axis, or an axis at another angle), or about more than two axes.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
selecting a first center point for a first portion of an image;
copying said first portion, centered about said first center point, to a buffer; and
inverting said copied first portion about a first edge of said portion.

2. The method of claim 1 further comprising inverting said copied first and inverted portions about a second edge of said copied first and inverted portions.

3. The method of claim 1 further comprising inverting said copied first and inverted portions about a second edge of said copied first and inverted portions, said second edge being orthogonal to said first edge.

4. The method of claim 1 further comprising inverting said copied first and inverted portions about a second edge of said copied first and inverted portions, said second edge not being orthogonal to said first edge.

5. The method of claim 1 wherein, in response to user input, performing said selecting, copying and inverting on a larger version of said image.

6. The method of claim 1 further comprising:
copying a second portion of a larger version of said image to a second buffer, said second portion centered about a second center point corresponding to the first center point; and
inverting said second portion about a third edge of said copied second portion.

7. The method of claim 6 further comprising inverting said copied second portion and said inverted second portion about a fourth edge of said copied second portion and said inverted second portion.

8. The method of claim 1 further comprising offsetting said copied first portion before inverting said copied first portion.

9. An apparatus, comprising:
a display;
an input control;
storage on which an image is stored;
logic coupled to said display, said input control and said storage, said logic permits a first center point associated with a first portion of said image to be selected via the input control, copies said first portion to a buffer, and invert said copied first portion about a first edge of said portion.

10. The apparatus of claim 9 further comprising inverting said copied first and inverted portions about a second edge of said copied first and inverted portions.

11. The apparatus of claim 9 further comprising inverting said copied first and inverted portions about a second edge of said copied first and inverted portions, said second edge being orthogonal to said first edge.

12. The apparatus of claim 9 further comprising inverting said copied first and inverted portions about a second edge of said copied first and inverted portions, said second edge not being orthogonal to said first edge.

13. The apparatus of claim 9 wherein, in response to user input, performing said selecting, copying and inverting on a larger version of said image.

14. The apparatus of claim 9 further comprising:
copying a second portion of a larger version of said image to a corner of a second buffer, said second portion centered about a second center point corresponding to the first center point; and
inverting said second portion about a third edge of said copied second portion.

15. The apparatus of claim 14 wherein said logic inverts said copied second portion and said inverted second portion about a fourth edge of said copied second portion and said inverted second portion.

16. The apparatus of claim 9 wherein said logic offsets said copied first portion before inverting said copied first portion.

17. The apparatus of claim 9 wherein said apparatus comprises a camera.

18. A storage medium containing software that, when executed by a processor, causes the processor to:
select a first center point for a first portion of an image;
copy said first portion, centered about said first center point, to a buffer; and
invert said copied first portion about a first edge of said portion to generate a first reflected image.

19. The storage medium of claim 18 wherein said software further causes the processor to invert said copied first and inverted portions about a second edge of said copied first and inverted portions.

20. The storage medium of claim 18 wherein said software further causes the processor to generate a second reflected image, corresponding to said first reflected image, of a larger version of said image.
